(19) United States
(12) Patent Application Publication
(10) Pub. No.: US 2005/0123649 A1
(43) Pub. Date: Jun. 9, 2005

(54) Acid-stable soy protein and fortified food or beverage

(75) Inventors: Daniel Ernesto Benitez, Vinton, IA (US); Jack William Maegli, Beloit, WI (US); Dustan Theodore Doud, Clinton, WI (US); Homer Narber Showman, Shellsburg, IA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Kerry Group Services International, Ltd., County Kerry (IE)

(21) Appl. No.: 10/983,217

(22) Filed: Nov. 5, 2004

Related U.S. Application Data
(60) Provisional application No. 60/517,466, filed on Nov. 5, 2003.

(51) Int. Cl. A23L 1/30

(52) U.S. Cl. 426/72

(57) ABSTRACT

A water-soluble acid stable soy protein, methods for making same and acidic food or acidic beverage fortified therewith. Particularly, this invention is useful in the pH range of 3.5 to 4.1 where other soy protein fortification methods do not work. The invention is comprised of a soy protein, a thermal treatment method to solubilize at least 90% of the protein, an acidification of the protein to a point preferably significantly below the iso-electric value, and a partial neutralization to bring the product proximal to the intended pH of the application it will be used in.

### BACKGROUND OF THE INVENTION

The present invention relates to soy protein, and, more particularly, to water-soluble acid-stable soy protein, to methods for making water-soluble acid-stable soy protein, and to foods and beverages that are fortified with water-soluble acid-stable soy protein.

Protein fortification of food and beverage is desirable to balance the nutritional aspect of the product in many applications. Intrinsically, beverages are too high in carbohydrate and too low in protein to satisfy beverage meal replacement or the high protein contents required by some popular diet plans such as Atkins. Some foods such as Yogurt when sold into the nutritional foods market are also below the desired protein content. Protein fortification with soy proteins is particularly desirable because of the amino acid profile of soy protein and because soy proteins work quite well in pH neutral applications where they are highly soluble. In acidic foods and beverage (e.g., below about pH 4.5), soy protein is much less soluble and can form precipitated micro agglomerates that give the product a “chalky” or dry mouth feel. Over time, insoluble protein will settle out of low viscosity food and beverage forming a separate and undesirable layer. Accordingly, there remains a need in the art for soy protein that is water soluble, is stable in acidic environments, and that can be included in food and/or beverage for fortifying the food and/or beverage with protein.

### SUMMARY OF THE INVENTION

The present invention provides a water-soluble acid-stable soy protein, and food and/or beverage which includes water-soluble acid-stable soy protein. The soy protein is soluble in water at a pH less than the pH at which the unstabilized soy protein is soluble in water. The acid-stable soy protein can be formed separately from the food or beverage, or, where desired, the acid-stable soy protein can be formed in situ in the food or beverage provided the food or beverage is not adversely affected by the treatment of the soy protein to render it acid-stable.

The acid-stable soy protein is preferably designed for food and beverage where the pH of the food or beverage is below that where unstabilized soy protein is normally soluble. The acid-stable protein of the present invention can be used in acidic food and beverage where the pH of the food or beverage is about 4.5 or less, and where, because of the proximity of the pH of the acidic environment to the iso-electric point of soy protein, that is, the pH where protein is least soluble, soy protein fortification with soy protein that is not acid-stable is unsatisfactory.

In another aspect, the present invention provides food or beverage that includes acid-stable soy protein. The acid-stabilized soy protein can be added to food or to beverage to improve protein content, or the acid-stabilized protein can be formed in situ in the food or beverage. The present invention is particularly useful in providing acidic food or acidic beverage that is fortified with soy protein. Methods for the fortification of food or beverage are also provided.

The present invention also provides a method for the preparation of water-soluble acid-stable soy protein. The method includes forming a suspension of soy protein in a liquid; applying a thermal treatment to the soy protein suspension for a time and under pressure sufficient to solubilize the soy protein in the liquid; cooling the suspension and reducing the pressure to ambient pressure; adding acid to the soy protein suspension in an amount such that the pH of the solution is at or below the iso-electric point of the protein to form an acidified soy protein suspension; mixing the acidified soy protein suspension in a high shear mixer; and optionally, neutralizing the acidified solution with a base to the approximate pH of the intended use of the water-soluble acid stable protein. Once formed, the water-soluble acid-stable soy protein can be stored in any of a variety of forms, including as a liquid or as a solid, such as for example, as a spray dried solid.

### DETAILED DESCRIPTION OF THE PREFERRED EMBODIMENTS

The present invention provides a water-soluble acid-stable soy protein. The soy protein in accordance with the invention is particularly well-suited to fortify acidic food and acidic beverage because the soy protein is stable in acidic environment and will not separate or agglomerate to any appreciable extent, if at all. The acid-stable soy protein of the invention is soluble in water at a pH less than the pH at which the unstabilized protein is soluble.

Enzyme-modified soy protein known in the art, such as, for example, Iso 5 enzyme-modified soy powder available from Nutriant, a division of Kerry Inc., can also be acid-stabilized in accordance with another aspect of the present invention. The acid-stable enzyme-modified soy protein is also soluble in water and can be used in acidic food and acidic beverage as well.

In keeping with other embodiments of the invention, acidic foods and acidic beverages can be fortified with soy protein using the water-soluble acid-stable soy protein, enzyme-modified soy protein or combinations thereof, described herein. The method of fortifying such food and beverage with acid-stable soy protein comprises blending the food or beverage of choice with the water-soluble acid-stable soy protein described herein. Blending can be accomplished, for example, by simply mixing the food or beverage with the acid-stable soy protein. Additionally, the acid-stable soy protein can be formed in situ in the food or beverage, provided the food or beverage is not harmed or destroyed. The present invention also provides an acidic beverage comprising a water-soluble acid-stable soy protein and it also provides an acidic food product comprising a water-soluble acid-stable soy protein. As described above, the acid-stable soy protein is soluble in water at a pH less than the pH at which the unstabilized protein is soluble. Preferably, acid-stable protein is soluble in water at a pH of about 4.5 or less, more preferably at a pH of from about 3 to about 4.5 and even more preferably at a pH of from about 3.5 to about 4.1. Typically, about 90% of the acid-stable soy protein is soluble in water at a pH in the range of from about 3.5 to about 4.1.

Water-soluble acid-stable soy protein is generally prepared by acidifying a suspension of soy protein such that the pH of the suspension is at or below the iso-electric point of the soy protein. Preferably, the acidification of the soy protein is to a pH significantly below the iso-electric point in order to increase the amount of acid-stable protein that is soluble in the suspension. Also, it is preferred to balance the pH achieved during acidification with the pH of the intended use of the acid-stable product to decrease neutralization that could be required to bring the pH of the acid-stable protein proximal to the pH of the intended application.

The preferred method for the preparation of water-soluble acid-stable soy protein comprises forming a suspension of soy protein in a liquid; applying a thermal treatment to the soy protein suspension for a time and under pressure sufficient to solubilize the soy protein in the liquid; cooling the suspension and reducing the pressure to ambient pressure; adding acid to the soy protein suspension in an amount such that the pH of the solution is at or below the iso-electric point of the protein to form an acidified soy protein suspension; mixing the acidified soy protein suspension in a high shear mixer; and optionally, neutralizing the acidified solution with base to the approximate pH of the intended use of the water-soluble acid-stable protein. It will also be appreciated that the process described above can be varied as desired, yet still be used to make the acid-stable soy protein. For example, following the formation of the suspension of soy protein in a liquid, the soy protein suspension can be acidified and the acidified soy protein suspension can be subjected to thermal treatment and high shear mixing. Generally, thermal treatment before acidification is preferred, since the further the solution is from the iso-electric point of the protein when the solubilization step is employed, the better the solubility is usually obtained.

It will also be appreciated that soy protein can be made acid-stable in situ in food and/or beverage. For example, soy protein is added to the food or beverage and thermal treatment is applied to the food or beverage modified with soy protein, preferably, at or about the pH of the food or beverage, for a time and under pressure sufficient to solubilize the soy protein in the food or beverage. Acid is then added to the food or beverage in an amount such that the pH of the food or beverage is below the iso-electric point of the soy protein. The food or beverage is then mixed in a high shear mixer, and optionally neutralized with base, preferably, to the natural pH of the food or beverage.

The method by which the soy protein suspension is formed is not critical to the invention. For example, the suspension can be formed from soy protein isolates, or it can be the soy suspension formed during the process used to make protein isolate. Typically, the solids content of the soy protein is sufficiently low that the soy protein does not agglomerate during thermal treatment. For example, soy protein can be stabilized in liquid, preferably water, by adding soy protein in powder form to a liquid such as potable water at a temperature of approximately 70° F. in a swept wall liquid mixing vat, such as a Groen kettle or the like. When native protein is used, it is preferable to adjust the protein to water ratio to provide a weight solids percentage of protein of 15% or less and, preferably, to about 10%. When an enzyme-modified soy protein is used, as is common in producing low viscosity beverages, the protein to water ratio is preferably adjusted to provide a weight solids percentage of protein of about 20% or less, and preferably of about 14%.

Preferably, the pH of the soy protein suspension is adjusted prior to the high shear thermal treatment of the suspension. The pH is adjusted to a pH in the range such that the soy protein is soluble in the liquid and such that the soy protein does not exhibit Maillard browning reactions during high shear thermal treatment. If the pH is too low, it will be difficult to dissolve all of the soy protein. If the pH is too high, the product will exhibit Maillard browning reactions during subsequent thermal treatment. Typically, the pH is adjusted to a pH of from about 6.8 to about 7.4, preferably 7.2. The pH can be adjusted with a suitable base, such as potassium hydroxide or the like, or with a suitable acid such as phosphoric acid or the like, as needed to achieve the desired pH.

The temperature and pressure of the thermal treatment of the soy protein suspension are preferably controlled so as to cause the soy solids in the suspension to become soluble in the liquid. Thermal treatment carried out at a temperature of from about 150° F. to about 300° F. is suitable to solubilize soy protein in the liquid. A temperature of about 270° F. is preferred. A temperature of about 260° F. is particularly preferred. Similarly, thermal treatment carried out at a pressure in the range of from about 5 to about 70 psi is suitable to solubilize the soy protein. Hold time, that is, the time for which the thermal treatment at the pre-selected temperature and pressure is maintained, is typically from about 5 seconds to about 3 minutes, and is typically inversely proportional to the temperature of the treatment. A hold time of about one minute is preferred.

Various commercially available mixers, pasteurization units and the like are available for assisting in the practice of the method of preparing the water-soluble acid-stable soy protein of the present invention. The use of such equipment is described below solely for the purpose of illustrating the method of the present invention, and it is not intended to in any way limit the scope of the invention or foreclose the use of other equipment in carrying out the invention.

In keeping with the invention, at least 90% of the soy protein is solubilized by forming a suspension of soy protein at about 15% solids or less (about 20% solids or less in the case of enzyme modified protein) at, preferably, a pH of 7.2, and applying high shear thermal treatment to the suspension. Too high of a solids content (e.g., greater than about 20% native protein) can cause agglomeration of the protein during thermal treatment. Accordingly, the solids content is selected so as to avoid agglomeration of the protein during thermal treatment. The soy protein suspension is then subjected to thermal treatment such as, for example, by recirculating the suspension through a high shear mixing apparatus, such as a Silverson pump, until the temperature of the recirculating suspension/solution has reached approximately 200° F.

Thermal treatment can also be carried out with a UHT indirect steam pasteurization unit, such as a Unitherm, until the temperature of the recirculating suspension/solution reaches approximately 230° F., preferably at a pressure of about 20 to 30 psi under turbulent flow, and then cooled to approximately 50° F. before exiting the unit.

Thermal treatment can also be carried out with a UHT direct steam sterilization unit until the temperature of the recirculating suspension/solution reaches approximately 270° F. at a pressure of 60 psi, followed by a pressure relief to vent the product back to atmospheric conditions.

After thermal treatment, protein solubility is assessed. In the preferred methodology, the thermally treated soy protein solution is centrifuged at 5000 times the force of gravity for 2 minutes. The amount of weight solids present in the liquid decant from the former in proportion to the total amount of protein present in the sample represents the percentage in solution. If the desired amount of protein solubility is not achieved, e.g., on the order of at least about 70%, preferably on the order of at least about 80%, and most preferably on the order of at least about 90%, the protein solids should be diluted with water and subsequent thermal treatment to improve the percentage of soy protein that is solubilized.

After the solubilization process, the temperature is reduced to 70° F. by means of a cooling jacketed vat or an inline swept wall continuous cooler such as a Thermutator or the like to prevent cooked flavors from developing.

After solubility is achieved, the solution is acidified, preferably with phosphoric acid, to a pH below the iso-electric point of the soy protein. The farther below the iso-electric point the acidification is done, the better the solubility of the acid-stable protein will be in water. However, acidification is preferably not so great that excessive subsequent neutralization is required to bring the pH of acid-stable protein to the pH of the desired application. Other acids such as hydrochloric or citric can be used, but [the] phosphoric acid is preferred because it tends to deter precipitation of the protein, possibly via disruption of hydrogen bonding within the protein from the phosphate anion. Preferably, the solution is acidified to a pH of about 3.3 or less. During the acidification process, it is desirable to apply high shear mixing to prevent agglomeration when passing through the iso-electric point of the protein.

After the solubilization and acidification of the soy protein suspension, it is desirable to again assess protein solubility by the centrifuge analysis described above. If less than 90% of the protein is soluble, the solution should be acidified further, such as to a pH of 3.0 and solubility re-assessed.

The pH of the food or beverage of intended application of the water-soluble acid-stable soy protein of the present invention is assessed and the pH of the acid-stable soy protein to be added thereto is adjusted to reasonably match the food or beverage of intended application. Fruit beverage applications are typically at a pH in the range of about 3.5 to about 4.1. Typically, for such applications, the pH of the acid-stable soy protein is raised using a base or buffer, such as potassium hydroxide (25% solution), trisodium phosphate buffer, or the like. The pH of the acid-stable soy protein should remain below the iso-electric point of the protein, i.e., pH about 4.5, to provide for long term shelf stability of the acid-stable soy protein product.

The acid-stable soy protein can be used as a liquid directly into the application, condensed via treatment with an evaporator, or dried, preferably spray dried, for use at a later point in time or location.

It is possible to perform the thermal solubility step described at the lower pH of the acidification soy protein solution. However, thermal treatment at the low pH is not particularly preferred since the farther the solution is from the iso-electric point of the protein when the solubilization step is employed, the better the solubility usually obtained.

The following Examples are illustrative of, but not in limitation of, the present invention.

### EXAMPLE 1

This Example illustrates the preparation of water-soluble acid-stable soy protein. In this Example, the soy protein is prepared using the high shear cook method.

| | Weight- |
|---|---|
| Ingredient | percent |
| Iso 3 Soy Protein Powder (80% protein) | 10.00 |
| Phosphoric Acid (25%) | 0.03 |
| Potassium Hydroxide (25%) | 0.01 |
| Water | 89.97 |

In this Example, Iso 3 soy protein powder was obtained from Nutriant (a division of Kerry Inc.), the phosphoric acid and potassium hydroxide from TAB Chemicals.

The Iso-3 soy protein powder is reconstituted in water in a Stephan model 11 mixer with the water indicated at 70° F. The pH is recorded and adjusted if necessary to 7.1 (dilute potassium hydroxide to raise, dilute phosphoric acid to lower). The solution is heated to 130° F., and pumped with a Triclover model PR 310M-U-UC6-S-T positive feed pump through a Silverson model 425LS in line high shear mixer. The mixing pump is fit with a recirculation loop and backpressure valve such that the product makes multiple passes through the pump before exiting the process. The Triclover feed pump speed is adjusted such that the product residence time in the loop results in a temperature rise to approximately 200° F.

The product is next checked for soluble protein as described above, then cooled to approximately 70° F. in the Stephan model 11 using cool water circulated through the external jacket of the vat.

Using 25% phosphoric acid, the product is titrated to a pH of approximately 3.3 in the Stephan mixer while being vigorously agitated, then titrated to a higher pH of approximately 3.8 with 10% potassium hydroxide. The resulting solution is adjusted to approximately 130° F., homogenized through a Gaulin model M-3 homogenizer at 2000 psi first stage pressure and 500 psi second stage pressure, then dried on an APV Anhydro 22039 centrifugal atomizer compact spray drier with an approximate inlet and outlet temperature of 325° F. and 175° F., respectively.

### EXAMPLE 2

This Example illustrates the preparation of water-soluble acid-stable soy protein. In this Example, the soy protein is prepared using a UHT direct steam process.

| | Weight- |
|---|---|
| Ingredient | percent |
| Soy Curd -pH 4.5 (30% TS) | 30.00 |
| Phosphoric Acid (25%) | 0.03 |
| Potassium Hydroxide (25%) | 0.01 |
| Water | 69.97 |

In this Example, the acid soy curd protein was obtained from Nutriant's soy protein manufacturing process, the phosphoric acid and potassium hydroxide from TAB Chemicals.

The acid soy curd is reconstituted in water in an APV model CLV-25 multivertor with the water indicated at 70° F. The curd is neutralized to pH 7.1 with dilute potassium hydroxide. The solution is adjusted to 130° F., and pumped through a Cherry Burell model XLV UHT steam injection sterilizer. The product temperature is adjusted to 285° F. with a backpressure of 60 psi and a holding tube of such length that the product has a hold time of approximately 30 seconds before entering the flash chamber. In the flash chamber enthalpy from the released steam lowers product temperature to approximately 210° F.

The product temperature is then lowered to 70° F. with a Cherry Burrell model 6×36 BWS Votator 2 with glycol jacket cooling.

The product is next checked for soluble protein as described above.

Using 25% phosphoric acid, the product is titrated to a pH of approximately 3.3 in a Multivertor while being vigorously agitated, then titrated to a higher pH of approximately 3.8 with 10% potassium hydroxide. The resulting solution is adjusted to approximately 130° F., homogenized through a Gaulin model M-3 homogenizer at 2000 psi first stage pressure and 500 psi second stage pressure, then dried on an APV Anhydro 22039 centrifugal atomizer compact spray drier with an approximate inlet and outlet temperature of 325° F. and 175° F., respectively.

### EXAMPLE 3

This Example illustrates a beverage fortified with water-soluble acid-stable soy protein.

| | Weight- |
|---|---|
| Ingredient | percent |
| White Grape Juice Concentrate 67 brix | 8.00 |
| Apple Concentrate 70 brix | 4.00 |
| Peach Concentrate 70 brix | 2.00 |
| Acid Stable Soy Powder (spray dried, pH 3.8) | 3.50 |
| Sucralose | 0.08 |
| Peach Flavor | 0.80 |
| Vanilla Flavor | 0.40 |
| Turmeric 10% water soluble | 0.40 |
| Monosodium Phosphate | 0.10 |
| Annatto 10% water soluble | 0.04 |
| Water | 80.78 |

In this Example, the juice concentrates were obtained from Treetop Inc., the sucralose from Splenda Inc., the peach flavor from Sunpure Inc., the vanilla from Virginia Dare, the monosodium phosphate from FMC, and the color (turmeric and annatto) from Chris Hansens Inc.

The acid-stable soy protein is dissolved in water utilizing a 5-gallon steam jacketed vat and a high shear agitator. Next the other ingredients are added and mixed for 5 minutes. The temperature is elevated to 165° F. for 1 minute and the product is homogenized (with a Gaulin model M-3) at 2000 psi first stage pressure, 500 psi second stage pressure (2500 psi total). The product is put back into the jacketed vat and cooled to 60° F. and stored under refrigerated conditions for up to 4 weeks.

### EXAMPLE 4

This Example illustrates a beverage fortified with water-soluble acid-stable soy protein.

| | Weight- |
|---|---|
| Ingredient | percent |
| White Grape Juice Concentrate 67 brix | 8.00 |
| Apple Concentrate 70 brix | 4.00 |
| Peach Concentrate 70 brix | 2.00 |
| Iso 5 Enzyme Modified Soy Protein Powder | 3.50 |
| Sucralose | 0.08 |
| Peach Flavor | 0.80 |
| Vanilla Flavor | 0.40 |
| Turmeric 10% water soluble | 0.40 |
| Monosodium Phosphate | 0.20 |
| Annatto 10% water soluble | 0.04 |
| Water | 80.78 |

In this Example, the juice concentrates were obtained from Treetop Inc., the Iso 5 enzyme modified soy protein from Nutriant, the sucralose from Splenda Inc., the peach flavor from Sunpure Inc., the vanilla from Virginia Dare, the monosodium phosphate from FMC, and the color (turmeric and annatto) from Chris Hansens Inc.

The soy protein is dissolved in water utilizing a 5-gallon steam jacketed vat and a high shear agitator. Next the other ingredients are added and mixed for 5 minutes. The pH is checked and adjusted to approximately 3.8 using phosphoric acid to lower the pH or potassium hydroxide to raise the pH. In this Example, a greater level of monosodium phosphate is used in order to increase the phosphate concentration of the fortified beverage and as a complement to the lower phosphate content of the Iso 5 (non-acid-stable) soy protein powder.

The product is then processed with a Tetra Therm Aseptic VTIS direct steam UHT sterilizer where it is preheated in a plate heat exchanger to about 80° C., then further heated with steam injection to 285° F. under 50 psi back pressure. After a hold period of approximately 5 seconds it enters the flash chamber, where enthalpy from the released steam lower the temperature to approximately 210° F. The product is then homogenized with a Tetra Alex homogenizer and cooled in a plate heat exchanger to 50° F. and is ready to aseptically pack.

1. A water-soluble acid-stable soy protein, wherein said soy protein is soluble in water at a pH less than the pH at which the unstabilized protein is soluble.

2. A water-soluble acid-stable soy protein, wherein said soy protein is soluble in water at a pH of about 4.5 or less.

3. The water-soluble acid-stable soy protein of claim 2, wherein said soy protein is soluble in water at a pH of from about 3 to about 4.5.

4. The water-soluble acid-stable soy protein of claim 2, wherein said protein is soluble in water at a pH of from about 3.5 to about 4.1.

5. The water-soluble acid-stable soy protein of claim 1, 2, 3 or 4, wherein at least 90% of said protein is soluble in water at a pH of from about 3.5 to about 4.1.

6. An acidic beverage comprising a water-soluble acid-stable soy protein, wherein said soy protein is soluble in water at a pH of from about 3.0 to about 4.5.

7. The beverage of claim 6, wherein said beverage has a pH of 4.5 or less.

8. The beverage of claim 6, wherein said beverage has a pH of from about 3 to about 4.5.

9. The beverage of claim 6, wherein said beverage has a pH of from about 3.5 to about 4.1.

10. An acidic food product comprising a water-soluble acid-stable soy protein, wherein said soy protein is soluble in water at a pH of from about 3.0 to about 4.5.

11. The food product of claim 10, wherein said food product has a pH of 4.5 or less.

12. The food product of claim 10, wherein said food product has a pH of from about 3 to about 4.5.

13. The food product of claim 10, wherein said food product has a pH of from about 3.5 to about 4.1.

14. A method for fortifying an acidic beverage with soy protein, wherein said method comprises adding to said acidic beverage a water-soluble acid-stable soy protein.

15. The method of claim 14, wherein said soy protein is soluble in water at a pH of about 4.5 or less.

16. The method of claim 14, wherein said soy protein is soluble in water at a pH of from about 3 to about 4.5.

17. The method of claim 14, wherein said soy protein is soluble in water at a pH of from about 3.5 to about 4.1.

18. The method of claim 14, 15, 16 or 17, wherein at least 90% of said soy protein is soluble in water at a pH of from about 3.5 to about 4.1.

19. A method for fortifying an acidic food product with soy protein, wherein said method comprises adding to said food product a water-soluble acid-stable soy protein.

20. The method of claim 19, wherein said soy protein is soluble in water at a pH of about 4.5 or less.

21. The method of claim 19, wherein said soy protein is soluble in water at a pH of from about 3 to about 4.5.

22. The method of claim 19, wherein said soy protein is soluble in water at a pH of from about 3.5 to about 4.1.

23. The method of claim 19, 20, 21, or 22, wherein at least 90% of said soy protein is soluble in water at a pH of from about 3.5 to about 4.1.

24. A method for the preparation of water-soluble acid-stable soy protein comprising:
forming a suspension of soy protein in a liquid;
applying a thermal treatment to the soy protein suspension for a time and under pressure sufficient to solubilize the soy protein in the liquid;
cooling the suspension and reducing the pressure to ambient pressure;
adding acid to the soy protein suspension in an amount such that the pH of the suspension is at or below the iso-electric point of the protein to form an acidified soy protein suspension;
mixing the acidified soy protein suspension in a high shear mixer; and
optionally, neutralizing the acidified solution with base to the approximate pH of the intended use of the water-soluble acid-stable protein.

25. The method of claim 24, wherein following the formation of the suspension of soy protein in a liquid, the soy protein suspension is acidified and the acidified soy protein suspension is subjected to thermal treatment and high shear mixing.

26. The method of claim 24, wherein the solids content of the soy protein suspension is sufficiently low that the soy protein does not agglomerate during thermal treatment.

27. The method of claim 24, wherein acid is added to lower the pH to about 3.3 or less.

28. The method of claim 24, wherein the solids content of the soy protein suspension is less than about 20% by weight solids.

29. The method of claim 24, wherein the solids content of the soy protein suspension is less than about 15% by weight solids.

30. The method of claim 24, wherein the solids content of the soy protein suspension is less than about 10% by weight solids.

31. The method of claim 24, 25, 26, 27, 28, 29 or 30, wherein the pH of the soy protein suspension is adjusted prior to the high shear thermal treatment of the suspension to a pH in the range such that the soy protein is soluble in the liquid and such that the soy protein does not exhibit Maillard browning reactions during high shear thermal treatment.

32. The method of claim, 24, 25, 26, 27, 28, 29 or 30, wherein the pH of the soy suspension is adjusted to a pH of from about 6.8 to about 7.4.

33. The method of claim 24, 25, 26, 27, 28, 29 or 30, wherein the pH of the soy suspension is adjusted to about a pH of about 7.2.

34. The method of claim 24, 25, 26, 27, 28, 29 or 30, wherein said soy protein suspension is the soy protein suspension formed during a process for making a protein isolate.

35. The method of claim 24, 25, 26, 27, 28, 29 or 30, wherein said suspension of soy protein is formed by mixing a dry protein isolate or concentrate with water.

36. The method of claim 24, 25, 26, 27, 28, 29 or 30, wherein said suspension of soy protein is heated to a temperature of from about 150° F. to about 300° F. and under sufficient pressure to keep the suspension in the liquid state.

37. The method of claim 36, wherein the temperature is about 270° F.

38. The method of claim 36, wherein the temperature is about 260° F.

39. The method of claim 36, wherein the pressure is from about 5 to 70 psi.

40. The method of claim 36, wherein the pressure is from about 50 to 60 psi.

41. The method of claim 36, wherein the temperature and pressure of the heat treatment are held for a hold time of from about 5 seconds to about 3 minutes.

42. The method of claim 36 wherein the hold time is about 1 minute.

43. A method for the preparation of water-soluble acid-stable soy protein comprising:
forming a suspension of soy protein in a liquid, said suspension being 15% by weight solids or less;
optionally, adjusting the pH of the suspension to a pH in the range of about 6.8 to about 7.4;
heating the soy protein suspension at a temperature of from about 150° F. to about 300° F., with a hold time of from about 5 seconds to about 3 minutes and under pressure of from about 5 to about 70 psi to solubilize the soy protein in the liquid;
cooling the suspension and reducing the pressure to ambient pressure;
adding an acid to the soy protein suspension in an amount such that the pH of the solution is at or below the iso-electric point of the protein to form an acidified soy protein suspension;
mixing the acidified soy protein suspension in a high shear mixer; and
optionally, neutralizing the acidified solution with a base to the approximate pH of the intended use of the water-soluble acid-stable protein.

44. The water-soluble acid-stable soy protein of claim 1, 2, 3 or 4, wherein said soy protein is enzyme-modified soy protein.

45. The acidic beverage of claim 6, wherein the water-soluble acid-stable soy protein is an enzyme-modified soy protein.

46. The acidic food product of claim 10, wherein the water-soluble acid-stable soy protein is an enzyme-modified soy protein.

47. A method for the preparation of a food or beverage comprising acid-stabilized soy protein, wherein said method comprises:
adding soy protein or enzyme-modified soy protein to said food or beverage to form a protein-modified food or beverage;
applying a thermal treatment to the protein-modified food or beverage for a time and under pressure sufficient to solubilize soy protein in the food or beverage;
cooling the thermally treated food or beverage and reducing the pressure to ambient pressure;
adding acid to the thermally treated food or beverage such that the pH of the food or beverage is at or below the iso-electric point of the protein to form an acidified soy protein food or beverage;
mixing the acidified soy protein food or beverage in a high shear mixer; and
optionally, neutralizing the acidified soy protein food or beverage with base.

48. The method of claim 47 wherein first acid is added to the protein-modified food or beverage such that the pH of the food or beverage is at or below the iso-electric point of the protein to form an acidified soy protein food or beverage, then the acidified soy protein food or beverage is thermally treated for a time and under pressure sufficient to solubilize soy protein in the food or beverage.

49. The method of claim 24 wherein acid is first added to the suspension of soy protein in liquid in an amount such that the pH of the suspension is at or below the iso-electric point of the protein to form an acidified soy protein suspension, followed by applying a thermal treatment to the acidified soy protein suspension for a time and under pressure sufficient to solubilize the soy protein.

50. A water-soluble acid-stable soy protein wherein said soy protein is at least about 90% soluble in aqueous solution at pH 3.5.

51. A water-soluble acid-stable soy protein wherein said soy protein is at least about 90% soluble in aqueous solution at pH 3.0.

52. A water-soluble acid-stable soy protein wherein said soy protein is at least about 90% soluble in aqueous solution at pH 3.8.
